(19) United States
(12) Patent Application Publication
(10) Pub. No.: US 2017/0200251 A1
(43) Pub. Date: Jul. 13, 2017

(54) DISPLAY CONTROL APPARATUS, PIXEL CLOCK CONTROL COMPONENT AND METHOD FOR DYNAMICALLY CONFIGURING A PIXEL CLOCK

(71) Applicants: Vincent Aubineau, Areches (FR); Ioseph E. Martinez-Pelayo, Austin, TX (US); Michael Andreas Staudenmaier, Munich (DE)

(72) Inventors: Vincent Aubineau, Areches (FR); Ioseph E. Martinez-Pelayo, Austin, TX (US); Michael Andreas Staudenmaier, Munich (DE)

(21) Appl. No.: 14/992,072

(22) Filed: Jan. 11, 2016

(51) Int. Cl. G06T 1/20; G09G 5/377; G09G 5/00

(52) U.S. Cl. CPC G06T 1/20; G09G 5/006; G09G 5/377; G09G 2320/0266; G09G 2310/08; G09G 2300/0452

(57) ABSTRACT

A display control apparatus comprising at least one display controller arranged to transmit composite pixel data to at least one display device at a rate defined by a pixel clock signal. The display control apparatus further comprises at least one pixel clock control component arranged to receive an indication of a number of graphics layers to be blended for the composite pixel data to be output, and to configure the pixel clock for the transmission of the composite pixel data to the at least one display device based at least partly on the received indication of the number of graphics layers to be blended.

### FIELD OF THE INVENTION

This invention relates to a method and apparatus for dynamically configuring a pixel clock, and in particular to a display control apparatus, a pixel clock control component and method therefor of dynamically configuration a pixel clock.

### BACKGROUND OF THE INVENTION

In embedded integrated circuit applications such as automotive applications, embedded devices include display controllers for infotainment and instrument cluster displays. In order to enable dynamic content creation with minimal CPU (central processing unit) intervention, it is known for such embedded display controllers to read (fetch) image data for individual graphics layers to be displayed directly from memory and blend the image data on-the-fly.

Graphical images displayed by automotive infotainment and instrument cluster displays are typically made up of a plurality of graphics objects/layers that are combined (blended) together to generate a composite image that is displayed to an end user. Accordingly, the embedded display controllers mentioned above fetch pixel data for multiple graphics layers, blend the pixel data for the multiple graphics layers to generate pixel data for the composite image to be displayed, and output the generated composite pixel data to a display device; all on-the-fly, one pixel at a time.

In order to avoid flickering of a graphical image being displayed, a sufficiently high frame rate, typically 60 frames per second (fps), must be maintained. To achieve such a frame rate of 60 fps, pixel data is transmitted from the display controller to the display device at a rate defined by a pixel clock. The pixel clock is conventionally configured to have a (fixed) clock rate that allows pixel data for a complete frame to be transmitted over a period of around 1/60^{th} of a second, with the display controller generating pixel data for one pixel of the composite image to be displayed each cycle of the pixel clock.

However, when a large number of graphics layers are to be blended to generate pixel data to be displayed, a lack of bandwidth for fetching image data or for processing (blending) the image data may result in pixel data for the composite image not being generated in time for the respective pixel clock cycle. This can result in artefacts appearing on the graphical image displayed to the end user. Increasing the available bandwidth for fetching image data or for processing the image data would require a higher performance architecture to be implemented, increasing the cost of the system, as well as potentially increasing power consumption and heat generation as a result of the increased performance.

### SUMMARY OF THE INVENTION

The present invention provides a display control apparatus, a pixel clock control component and a method of dynamically configuring a pixel clock as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 illustrates a simplified example of a composite image.

FIG. 2 illustrates a simplified block diagram of an example of a display control apparatus.

FIG. 3 illustrates a simplified block diagram of an example of a display controller.

FIG. 4 illustrates a simplified block diagram of an example of a pixel clock control component.

FIG. 5 illustrates a simplified block diagram of an alternative example of a pixel clock control component.

FIG. 6 illustrates a simplified flowchart of an example of a method of dynamically configuring a pixel clock for transmission of composite pixel data to a display device.

### DETAILED DESCRIPTION OF THE PREFERRED EMBODIMENTS

In accordance with some examples of the present invention, there is provided a pixel clock control component arranged to dynamically configure a pixel clock based on a number of graphics layers to be blended. In particular, it is contemplated that such a pixel clock control component may be arranged to increase the period of the pixel clock when a large number of graphics layers are to be combined for a particular pixel of a composite image to be displayed. In this manner, the amount of time available to fetch the image data from memory and to generate the composite pixel data to be displayed may be increased. As a result, a lack of bandwidth for fetching image data or processing (blending) the image data is compensated for, reducing the likelihood, and preferably eliminating altogether, the appearance of artefacts on the graphical image displayed to the end user.

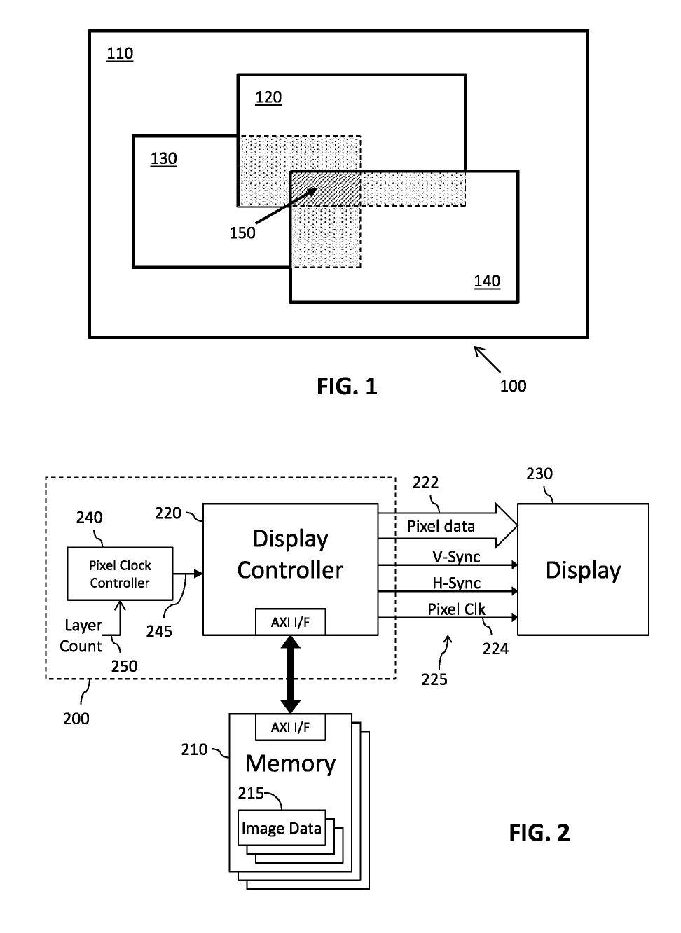

FIG. 1 illustrates a simplified example of a composite image 100 being displayed on a display device. The composite image 100 illustrated in FIG. 1 is a composition of a background graphics layer 110 and three further foreground graphics layers 120-140.

Each pixel of the composite image 100 consists of a composition of pixel image data for one, two three or four of the graphics layers 110-140. For example, pixels relating to locations within the composite image 100 that only include the background graphics layer 110 are derived from the corresponding pixel data for just the background graphics layer 110. Conversely, pixels relating to locations where, for example, all four graphics layers 110-140 overlap within the composite image 100, such as the region indicated at 150, are derived from a composition of the corresponding pixel data for all four graphics layers 110-140.

Referring now to FIG. 2, there is illustrated a simplified block diagram of an example of a display control apparatus 200, for example an embedded automotive display control apparatus. The display control apparatus 200 is coupled to one or more memory element(s) 210 within which image data 215 is stored. The image data 215 may be in the form of, for example, raw pixel data such as, for example, RGBA (Red, Green, Blue and Alpha) pixel data, and typically represents graphical objects (e.g. layers) that may be combined or otherwise used in combination to generate composite images to be displayed. The display control apparatus 200 further includes a display controller 220 arranged to read image data 215 to be displayed from the memory element(s) 210 and to transmit display data 225 to one or more display device(s) 230 to cause the display device(s) 230 to display a composite image generated from the read image data 215. For simplicity and ease of understanding, the display control apparatus 200 will hereinafter be described with reference to just a single memory element 210 and a single display device 230, as illustrated in FIG. 2.

The instantaneous display data 225 transmitted by the display controller 220 typically includes ‘composite’ pixel data 222 for one pixel of the composite image to be displayed. Such composite pixel data for a pixel of the composite image is generated by ‘blending’ pixel data for graphics objects/layers that correspond to the location of that pixel within the composite image. For example, composite pixel data for a pixel relating to a location within the composite image 100 of FIG. 1 where all four graphics layers 110-140 overlap will be generated by blending pixel data from each of the four graphics layers 110-140 corresponding to the location of that pixel within the composite image 100. The resulting composite pixel data 222 may consist of, for example, a 32-bit value made up of four 8-bit bytes defining the red, green, blue and alpha components of the pixel respectively.

The display data 225 further includes a pixel clock (Clk) signal 224. The pixel clock signal 224 delineates composite pixel data 222 for consecutive pixels to be displayed as they are transmitted by the display controller 220 to the display device 230. Thus, for each clock cycle of the pixel clock 224, the display controller 220 transmits the composite pixel data 222 for one pixel to the display device 230. The display data 225 further includes a vertical synchronisation (V-Sync) signal indicating when the current composite pixel data 222 being transmitted by the display controller 220 corresponds to a first pixel of a new frame to be displayed, and a horizontal synchronisation (H-Sync) signal indicating when the current composite pixel data 222 being transmitted by the display controller 220 corresponds to a first pixel of a row in the frame to be displayed.

In the illustrated example, the display control apparatus 200 further includes a pixel clock control component 240 arranged to output a pixel clock source signal 245. The pixel clock source signal 245 is provided to the display controller 220, and is used as a source for the pixel clock signal 224. For example, the display controller 220 may divide or multiply the pixel clock source signal 245 to create the pixel clock 224. Alternatively, the pixel clock source signal 245 may be used directly (i.e. without any division or multiplication) to derive the pixel clock signal 224. For clarity and ease of understanding, the pixel clock control component 240 has been illustrated and described as a separate functional component within the display control apparatus 200, discrete from the display controller 220. However, it will be appreciated that in some examples the pixel clock control component 240 may be integrated within the display controller 220.

In order to display the composite image 100 of FIG. 1, the display controller 220 of FIG. 2 fetches image data 215 for the individual graphics layers 110-140, blends the image data 215 for the graphics layers 110 - 140 to generate composite pixel data 222 for the composite image 100, and transmits the generated composite pixel data 222 to the display device 230, on-the-fly, one pixel at a time. Composite pixel data 222 is transmitted from the display controller 220 to the display device 230 at a rate defined by the pixel clock 224. Accordingly, to avoid artefacts appearing in the displayed image, the display controller 220 is required to generate pixel data 222 for one pixel of the composite image 100 to be displayed each cycle of the pixel clock 224.

For each pixel of the composite image 100, image data 215 is fetched from memory 210 for each graphics layer 110-140 associated with that pixel; the more graphics layers to be blended to create the composite pixel data 222, the more image data 215 that has to be fetched from memory 210. The speed at which such image data 215 can be fetched depends on the access speed of the memory device(s) 210 and the bandwidth of the interface(s) between the display controller 220 and the memory element(s) 210. Nevertheless, the more graphics layers for which image data 215 is fetched, the longer the time taken to fetch the image data 215.

Furthermore, the more graphics layers associated with a pixel of the composite image 100, the more layers of image data that need to be processed and blended to generate the composite pixel data 222 for that pixel. Accordingly, the more graphics layers associated with a pixel of the composite image 100, the greater the processing load for the display controller 220 to generate the composite pixel data 222 for that pixel.

If a large number of graphics layers are to be blended to generate pixel data for a pixel of the composite image 100 to be displayed, the time taken for the display controller 220 to fetch the image data 215 and to generate the pixel data 222 for the composite image will be greater than if a small number of graphics layers are to be blended.

The inventors have recognised that by increasing the period of the pixel clock 224 when a large number of graphics layers are to be blended for a particular pixel of the composite image 100 to be displayed, the amount of time available to the display controller 220 to fetch the image data 215 and to generate the composite pixel data 222 for the composite image 100 to be displayed may be increased. Accordingly, it is proposed to dynamically adapt the cycle period of the pixel clock 224 based (at least partly) on the number of graphics layers from which the pixel data 222 being transmitted to the display device 230 has been generated.

Accordingly, and referring back to FIG. 2, the pixel clock control component 240 is arranged to receive an indication 250 of a number of graphic layers to be blended for the composite pixel data 222, and to configure the pixel clock source signal 245, and thus the pixel clock 224, based (at least partly) on the received indication 250 of the number of graphic layers to be blended. For example, if the indicated number of graphic layers exceeds a predetermined threshold, the pixel clock control component 240 may be arranged to configure the pixel clock source signal 245 to have a lower clock rate. In this manner, the cycle period for the pixel clock 224 is extended to allow more time for the display controller to fetch and blend image data 215 to create the composite pixel data 222. Conversely, if the indicated number 250 of graphics layers is below the predetermined threshold, the pixel clock control component 240 may be arranged to configure the pixel clock source signal 245 to have a higher clock rate. In this manner, the cycle period for the pixel clock 224 may be shortened to achieve a minimum frame rate.

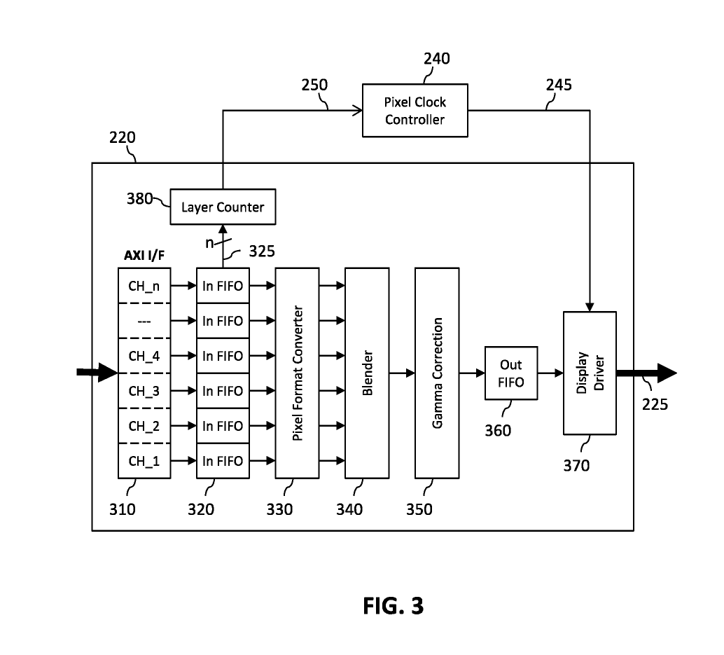

FIG. 3 illustrates a simplified block diagram of an example of the display controller 220 illustrated in FIG. 2. The display controller 220 includes an interface component 310 arranged to receive image data 215 from the memory element(s) 210. The interface component 310 includes a plurality of data channels (CH_1-CH_n), each data channel arranged to receive pixel image data 215 relating to one graphics layer. Received pixel image data 215 is stored within input (First-In-First-Out) buffers 320; each data channel of the interface component 310 storing received pixel image data 215 within its own input buffer 320.

A pixel format converter 320 receives the pixel image data for the individual graphics layers from the input buffers 320, which may be encoded in different formats, and converts the pixel image data into a common format, for example a 32-bit RGBA format, to enable subsequent blending of the layers to be more easily performed.

A blender 340 receives the converted pixel data for the individual graphics layers and blends the pixel data to generate composite pixel data to be displayed. A gamma correction component 350 performs gamma correction on the composite pixel data, and outputs the corrected composite pixel data to an output buffer 360. A display driver 370 reads the (gamma corrected) composite pixel data from the output buffer 360, and transmits display data 225 to the display device 130, including (see FIG. 2) the composite pixel data 222 read from the output buffer 360 along with the pixel clock signal 224, the V-Sync signal and the H-Sync signal. In the illustrated example, the interface component 310 consists of n data channels. In this manner, the display controller 220 is able to generate composite pixel data from a blend of up to n graphics layers.

The display controller 220 illustrated in FIG. 3 further includes a layer counter 380 arranged to receive indications 325 of which data channels the display controller 220 are receiving pixel image data 215, and to count how many of the n data channels are receiving pixel image data 215. In the illustrated example, the indications 325 of which of the data channels are receiving pixel image data 215 are provided by the input buffers 320. The layer counter 380 is arranged to output, as the indication 250 of the number of graphic layers, the count value of the number of data channels receiving pixel image data 215. In the illustrated example, the layer counter 380 has been illustrated and described as being implemented within the display controller 220. However, it will be appreciated that the layer counter 380 may equally be implemented separate from the display controller 220; for example as a standalone component, or integrated within, for example, the pixel clock control component 240.

Furthermore, it is contemplated that the indications 325 of which data channels the display controller 220 are receiving pixel image data 215 are not limited to being provided by the input buffers 320. For example, the display controller may include one or more registers (not shown) within which parameters for each layer are defined, for example the height and width of each layer. Accordingly, the indications 325 of which data channels the display controller 220 are receiving pixel image data 215 may be provided by such layer parameter registers.

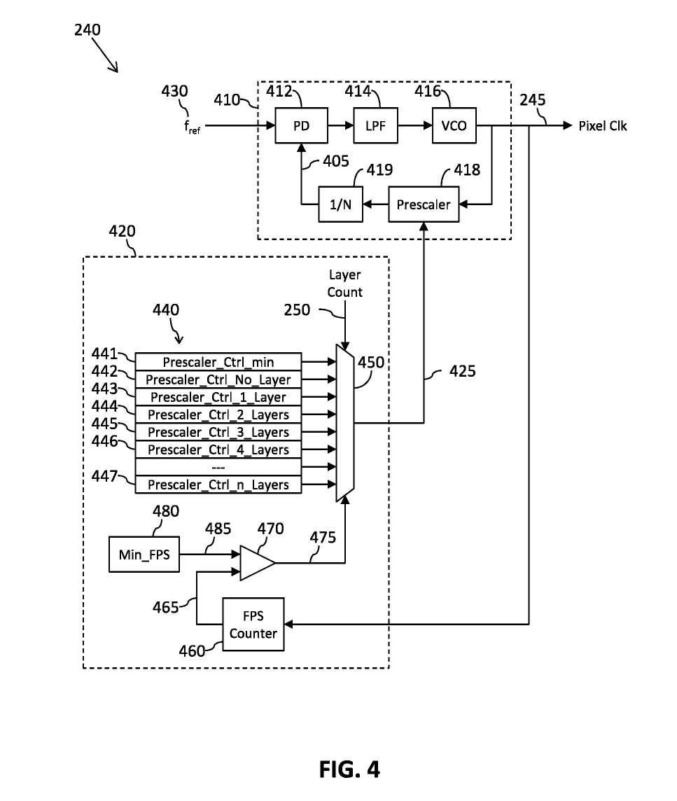

Referring now to FIG. 4, there is illustrated a simplified block diagram of an example of the pixel clock control component 240. The pixel clock control component 240 illustrated in FIG. 4 includes a clock signal generator 410 arranged to receive a control signal 425 and to generate the pixel clock source signal 245 based on the received control signal 425. In the example illustrated in FIG. 4, the clock signal generator 410 consists of a phase-locked loop (PLL). The PLL 410 consists of a phase detector 412 arranged to receive a reference frequency signal 430 and a feedback signal 405, and to output an error signal which is proportional to the phase difference of the reference frequency signal 430 and a feedback signal 405. The error signal is passed through a low pass filter 414 to a voltage controlled oscillator 416. The voltage controlled oscillator outputs an oscillating signal having a frequency dependent on the (filtered) error signal received thereby. As illustrated in FIG. 4, the oscillating signal output by the voltage controlled oscillator provides (at least the basis for) the pixel clock source signal 245. The PLL 410 further includes a feedback path consisting of, in the illustrated example, a prescaler component 418 and a frequency divider 419 coupled in series. The prescaler component 418 is arranged to receive at a first input thereof the oscillating signal output by the voltage controlled oscillator 416, and at a second input thereof the control signal 425, and to apply prescaling to the oscillating signal received from the voltage controlled oscillator 416. The prescaler component 418 outputs the prescaled oscillating signal to the frequency divider 419, which performs frequency division to the prescaled oscillating signal to generate the feedback signal 405.

It will be appreciated that the pixel clock control component 410 is not limited to being implemented by way of a phase locked loop. For example, the pixel clock control component 410 may alternatively consist of a clock multiplier/divider circuit arranged to receive a seed clock signal and to apply a different arrangement of multiplication and division to the seed clock signal to generate the pixel clock source signal 245 depending on the received control signal 425. In further alternative examples, the pixel clock control component 410 may consists of a phase frequency detector (PFD).

The pixel clock control component 240 further includes a configuration component 420 arranged to receive the indication 250 of the number of graphics layers to be blended and to configure and output the control signal 425 to the clock signal generator 410 based on the received indication 250 of the number of graphics layers to be blended. In the illustrated example, the configuration component 420 consists of one or more memory elements 440, for example in the form of a plurality of programmable registers, within which a plurality of clock configuration values 441-447 are stored.

In order to achieve a target frame rate of, for example, 60 fps, a ‘normal’ pixel clock rate (e.g. 9 MHz) may be appropriate. It may be determined that the display controller 220 is able to fetch and blend up to, for example, three graphics layers within a cycle period of the normal pixel clock rate. Accordingly, a clock configuration value 445 for achieving the normal pixel clock rate is stored within a programmable register 440 associated with three graphics layers. In this manner, when image data 215 for three graphics layers is to be read from memory 210 and blended to generate the composite pixel data 222, the pixel clock 224 is configured to have the normal pixel clock rate.

Conversely, clock configuration values 446-447 for achieving a reduced pixel clock rate (e.g. 7.83 MHz) may be stored within programmable registers 440 associated with more than three graphics layers. In this manner, when image data 215 for four or more graphics layers is to be read from memory 210 and blended to generate the composite pixel data 222, the pixel clock 224 is configured to have a reduced pixel clock rate, thereby providing the display controller 220 with more time to read and fetch the image data 215.

In some examples, it is contemplated that clock configuration values 442-444 for achieving an increased pixel clock rate (e.g. 9.26 MHz) may be stored within programmable registers 440 associated with less than three graphics layers. In this manner, when image data 215 for two or fewer graphics layers is to be read from memory 210 and blended to generate the composite pixel data 222, the pixel clock 224 is configured to have an increased pixel clock rate, thereby increasing the achieved frame rate to compensate for any reduction in the pixel frame rate as a result of the pixel clock 224 being configured to have a reduced pixel clock rate when image data 215 for four or more graphics layers is to be read from memory 210 and blended.

The configuration component 420 is arranged to selectively output as the control signal 425 one of the clock configuration values 441-447 based on the received indication 250 of the indication of the number of graphics layers to be blended. In the example illustrated in FIG. 4, this is achieved by way of a multiplexer component 450 arranged to receive at inputs thereof the clock configuration values 441-447 and at a control input thereof the indication 250 of the number of graphics layers, and to selectively output one of the clock configuration values 441-447 received thereby as the control signal 425.

In the illustrated example, the configuration component 420 is further arranged to receive an indication of a current frame rate for the display device 230 (FIG. 2), to determine whether the current frame rate is less than a minimum frame rate threshold, and to configure the control signal 425 to the clock signal generator 410 to generate the pixel clock source signal 245 to have a cycle period at least equal to a minimum frame rate clock cycle period. It is contemplated that such a minimum frame rate threshold may be representative of a minimum frame rate for avoiding flickering of a graphical image being displayed (typically 60 frames per second (fps)).

In the illustrated example the configuration component 420 includes a frame rate counter 460 arranged to receive the pixel clock source signal 245 and output an indication 465 of a current frame rate for the display device 230 based on the pixel clock source signal 245. For example, the frame rate counter 460 may be arranged to count the number of cycles for the received pixel clock source signal 245 over a predefined period of time, and to output the count value as the indication 465 of the current frame rate for the display device 230. The configuration component 420 further incudes a comparator component 470 arranged to receive at a first input thereof the indication 465 of the current frame rate for the display device 230. The comparator component 470 is further arranged to receive a minimum frame rate threshold value 485 (e.g. representative of a minimum frame rate for avoiding flickering of a graphical image being displayed), such as may be stored within a programmable register 480, and to output an indication 475 of whether the current frame rate for the display device 230 is less than the minimum frame rate threshold value 485.

In the illustrated example, the indication 475 output by the comparator component 470 is provided to a further control input of the multiplexer component 450. The multiplexer component 450 is thus further arranged to configure the control signal 425 to cause the clock signal generator 245 to generate the pixel clock source signal 245 to have a cycle period at least equal to a minimum frame rate clock cycle period; the minimum frame rate clock cycle period being that suitable for achieving at least a minimum frame rate (e.g. the minimum frame rate for avoiding flickering of a graphical image being displayed).

For example, and as described in greater detail below with reference to the method of

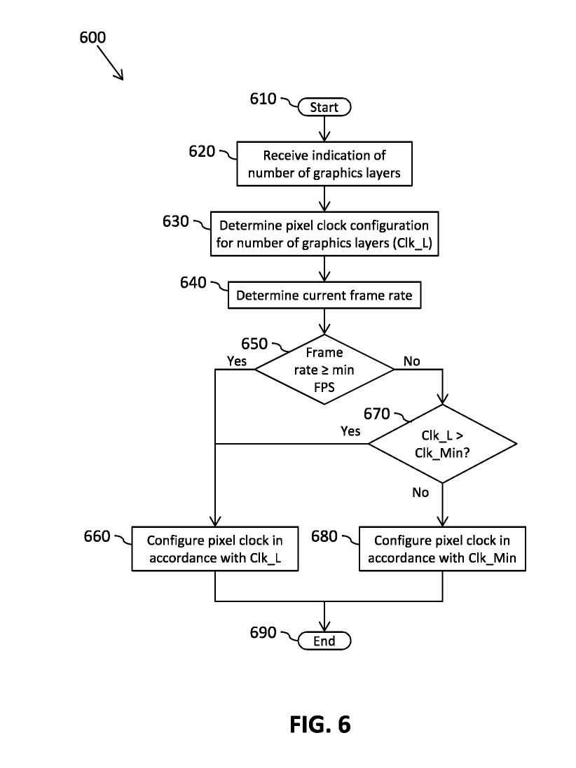

FIG. 6, if the indication 475 output by the comparator component 470 indicates that the current frame rate for the display device 230 is not less than the minimum frame rate threshold value 485, the multiplexer component 450 selectively outputs one of clock configuration values 442-447 corresponding to the indicated number of graphics layers as the control signal 425. However, if the indication 475 output by the comparator component 470 indicates that the current frame rate for the display device 230 is less than the minimum frame rate threshold value 485, the multiplexer component 450 may be arranged to output a minimum frame rate clock configuration value 441 as the control signal 425. In some examples, the minimum frame rate clock configuration value may be configured to equal the normal pixel clock rate (e.g. 9 MHz in the above described example).

In some alternative examples, if the indication 475 output by the comparator component 470 indicates that the current frame rate for the display device 230 is less than the minimum frame rate threshold value 485, the multiplexer component 450 may alternatively be arranged to determine whether the clock configuration value 442-447 corresponding to the indicated number of graphics layers would result in a shorter clock cycle period than that of the minimum frame rate clock configuration value 441, and if the clock configuration value 442-447 corresponding to the indicated number of graphics layers would result in a shorter clock cycle period than that of the minimum frame rate clock configuration value 441, the multiplexer component 450 selectively outputs the clock configuration values 442-447 corresponding to the indicated number of graphics layers. In this manner, the pixel clock source signal 245, and thereby the pixel clock 224 itself, may be configured to have an increased pixel clock rate, thereby increasing the achieved frame rate. Conversely, if the clock configuration value 445 corresponding to the indicated number of graphics layers would not result in a shorter clock cycle period than that of the minimum frame rate clock configuration value, the multiplexer component 450 is arranged to output the minimum frame rate clock configuration value 441, to assure a minimum frame rate clock cycle period for achieving at least a minimum frame rate.

By dynamically adapting the frequency/cycle period of the pixel clock 224 in this manner depending on the number of graphics layers to be blended in this manner, the amount of time available to the display controller 220 to fetch the image data 215 and to generate the pixel data 222 for the composite image 100 to be displayed may be increased when a large number of graphics layers are to be blended. As a result, a lack of bandwidth for fetching image data or processing (blending) the image data 210 may be compensated for, reducing the likelihood and preferably eliminating altogether the appearance of artefacts on the graphical image displayed to the end user.

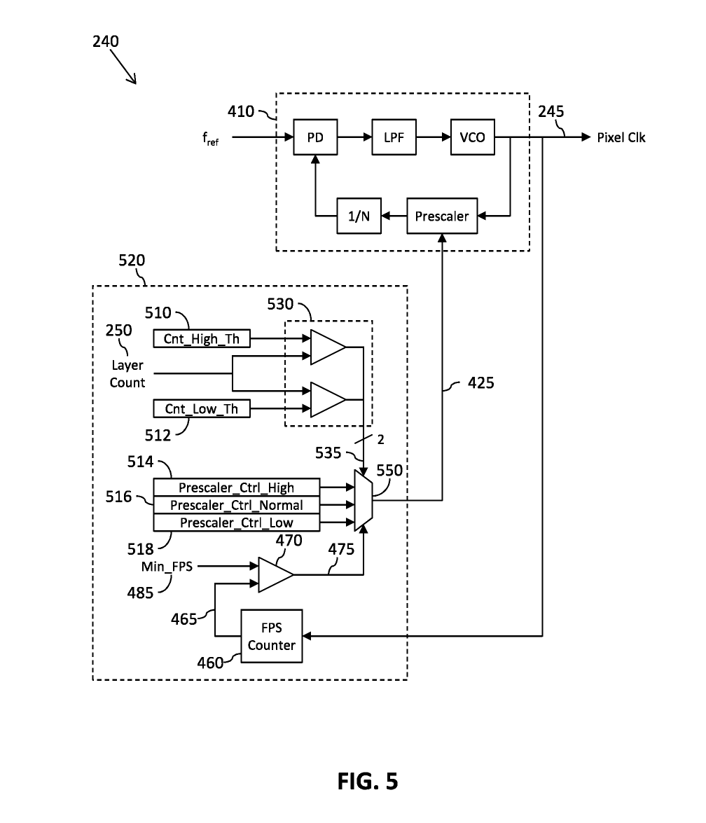

FIG. 5 illustrates a simplified block diagram of an alternative example of the pixel clock control component 240 of FIG. 2. For ease of understanding, those components and signals within the example pixel clock control component illustrated in FIG. 5 that are comparable to like components and signals within the pixel clock control component illustrated in FIG. 4 have been designated with the same reference numerals.

The pixel clock control component 240 illustrated in FIG. 5 includes a clock signal generator 410 arranged to receive a control signal 425 and to generate the pixel clock source signal 245 based on the received control signal. In the example illustrated in FIG. 5, the clock signal generator 410 also consists of a PLL, such as described in greater detail above with reference to FIG. 4. However, it will be appreciated that the pixel clock control component 410 is not limited to being implemented by way of a phase locked loop.

The pixel clock control component 240 illustrated in FIG. 5 further includes a configuration component 520 arranged to receive the indication 250 of the number of graphics layers to be blended and to configure and output the control signal 425 to the clock signal generator 410 based on the received indication 250 of the number of graphics layers to be blended. In the example illustrated in FIG. 5, the configuration component 520 includes a plurality of memory elements 510-518, for example consisting of programmable registers or the like.

A first, upper threshold value is stored within a first memory element 510, and a second, lower threshold value is stored within a second memory element 512. A comparator component 530 is arranged to compare the indication 250 of the number of graphics layers to the threshold values stored within the first and second memory elements 510, 512, and to output a select signal 535 based on the comparison of the indication 250 of the number of graphics layers to the threshold values stored within the first and second memory elements 510, 512. For example, and as illustrated in FIG. 5, the select signal 535 may consist of a 1-bit signal having: a ‘00’ value if the indicated number of graphics layers is less than the lower threshold value stored within the second memory element 512; a ‘01’ value if the indicated number of graphics layers is greater than the lower threshold value stored within the second memory element 512 but less than the upper threshold value stored within the first memory element 510; and a ‘11’ value if the indicated number of graphics layers is greater than the upper threshold value stored within the first memory element 510.

In the example illustrated in FIG. 5, three clock configuration values are stored within three further memory elements 514-518. For example a clock configuration value for a normal pixel clock rate (corresponding to a target frame rate, e.g. 60 fps) is stored within memory element 516, a clock configuration value for a reduced pixel clock rate is stored within memory element 518, and a clock configuration value for an increased pixel clock rate is stored within memory element 514.

The configuration component 420 is arranged to selectively output as the control signal 425 one of the clock configuration values stored within the memory elements 514-518 based on the select signal 535 output by the comparator component 530. In the example illustrated in FIG. 5, this is achieved by way of a multiplexer component 550 arranged to receive at inputs thereof the clock configuration values stored within the memory elements 514-518 and the select signal 535 at a control input thereof. In particular, the multiplexer component 550 in the illustrated example is arranged to output
the clock configuration value for the normal pixel clock rate stored within memory element 516 when the select signal 535 indicates that the indicated number of graphics layers is between the threshold values stored within the first and second memory elements 510, 512;
the clock configuration value for the reduced pixel clock rate stored within memory element 518 when the select signal 535 indicates that the indicated number of graphics layers is greater than higher threshold value stored within the first memory element 510; and
the clock configuration value for the increased pixel clock rate stored within memory element 514 when the select signal 535 indicates that the indicated number of graphics layers is lower than higher threshold value stored within the second memory element 512.

In the illustrated example, the configuration component 520 further includes a frame rate counter 460 arranged to receive the pixel clock source signal 245 and output an indication 465 of a current frame rate for the display device 230 based on the pixel clock source signal 245. The configuration component 520 further incudes a comparator component 470 arranged to receive at a first input thereof the indication 465 of the current frame rate for the display device 230. The comparator component 470 is further arranged to receive a minimum frame rate threshold value 485 and to output an indication 475 of whether the current frame rate for the display device 230 is less than the minimum frame rate threshold value 485.

In the illustrated example, the indication 475 output by the comparator component 470 is provided to a further control input of the multiplexer component 550. The multiplexer component 550 is thus further arranged to configure the control signal 425 to cause the clock signal generator 245 to generate the pixel clock source signal 245 to have a cycle period at least equal to a minimum frame rate clock cycle period, for example in a similar manner as described above with respect to FIG. 4.

It will be appreciated that the comparator component 530 may be arranged to compare the layer count indication 250 to any number of threshold values, and for the configuration component 520 to selectively output one of any corresponding number of clock configuration values based on such a comparison. For example, the comparator component 530 may be arranged to compare the layer count indication 250 to just a single threshold value, and the configuration component 520 may be arranged to selectively output one of two clock configuration values based on such a comparison. Alternatively, the comparator component 530 may be arranged to compare the layer count indication 250 to three or more threshold values, and the configuration component 520 may be arranged to selectively output one of four or more clock configuration values based on such a comparison.

Referring now to FIG. 6, there is illustrated a simplified flowchart 600 of an example of a method of dynamically configuring a pixel clock for transmission of composite pixel data to a display device, such as may be implemented within the display control apparatus of FIG. 2. The method starts at 610, and moves on to 620 with the receipt of an indication of a number of graphics layers to be blended for the composite pixel data. Next, at 630, a pixel clock configuration (Clk_L) for the indicated number of graphics layers is determined. In the illustrated example, a current frame rate for the display device is then determined, at 640, and compared to a minimum frame rate threshold value, at 650.

If it is determined that the current frame rate for the display device is greater than or equal to the minimum frame rate threshold value, the method moves on to 660 where the pixel clock is configured in accordance with the determined pixel clock configuration (Clk_L) for the indicated number of graphics layers. For example, one of a plurality of clock configuration values stored within one or more memory elements may be selectively output as a control signal to a pixel clock source signal generator based on the received indication of the number of graphics layers to be blended. Alternatively, the received indication of the number of graphics layers to be blended to one or more threshold values, and one of a plurality of clock configuration values stored within one or more memory elements may be selectively output as a control signal to a pixel clock source signal generator based on the comparison of the received indication of the number of graphics layers to be blended to the one or more threshold values. The method then ends, at 690.

Referring back to 650, if it is determined that the current frame rate for the display device is not greater than or equal to the minimum frame rate threshold value, the method moves on to 670, where in the illustrated example the determined pixel clock configuration (Clk_L) for the indicated number of graphics layers is compared to a minimum frame rate clock configuration value (Clk_min). If it is determined that the determined pixel clock configuration (Clk_L) for the indicated number of graphics layers would result in a longer clock cycle period than that of the minimum frame rate clock configuration value (Clk_min), the method moves on to 680, where pixel clock is configured in accordance with the minimum frame rate clock configuration value (Clk_min), to assure a minimum frame rate clock cycle period for achieving at least a minimum frame rate. The method then ends, at 690.

Conversely, if it is determined that the determined pixel clock configuration (Clk_L) for the indicated number of graphics layers would result in a shorter clock cycle period than that of the minimum frame rate clock configuration value, the method moves on to 660, where the pixel clock is configured in accordance with the determined pixel clock configuration (Clk_L) for the indicated number of graphics layers. In this manner, the pixel clock may be configured to have an increased pixel clock rate than for the minimum frame rate clock configuration value, thereby increasing the achieved frame rate. The method then ends, at 690.

Because the illustrated embodiments of the present invention may for the most part, be implemented using electronic components and circuits known to those skilled in the art, details have not be explained in any greater extent than that considered necessary as illustrated above, for the understanding and appreciation of the underlying concepts of the present invention and in order not to obfuscate or distract from the teachings of the present invention.

In the foregoing specification, the invention has been described with reference to specific examples of embodiments of the invention. It will, however, be evident that various modifications and changes may be made therein without departing from the scope of the invention as set forth in the appended claims and that the claims are not limited to the specific examples described above.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively ‘associated’ such that the desired functionality is achieved. Hence, any two components herein combined to achieve a particular functionality can be seen as ‘associated with’ each other such that the desired functionality is achieved, irrespective of architectures or intermediary components. Likewise, any two components so associated can also be viewed as being ‘operably connected,’ or ‘operably coupled,’ to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms ‘a’ or ‘an,’ as used herein, are defined as one or more than one. Also, the use of introductory phrases such as ‘at least one’ and ‘one or more’ in the claims should not be construed to imply that the introduction of another claim element by the indefinite articles ‘a’ or ‘an’ limits any particular claim containing such introduced claim element to inventions containing only one such element, even when the same claim includes the introductory phrases ‘one or more’ or ‘at least one’ and indefinite articles such as ‘a’ or ‘an.’ The same holds true for the use of definite articles. Unless stated otherwise, terms such as ‘first’ and ‘second’ are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

We claim:

1. A display control apparatus comprising at least one display controller arranged to transmit composite pixel data to at least one display device at a rate defined by a pixel clock signal; and
at least one pixel clock control component arranged to:
receive an indication of a number of graphics layers to be blended for the composite pixel data to be transmitted, and
configure the pixel clock based at least partly on the received indication of the number of graphics layers to be blended.

2. The display control apparatus of claim 1, wherein the pixel clock control component comprises:
a clock signal generator arranged to receive a control signal and to generate a pixel clock source signal based at least partly on the received control signal, and
a configuration component arranged to receive the indication of the number of graphics layers to be blended and to configure and output the control signal to the clock signal generator based at least partly on the received indication of the number of graphics layers to be blended.

3. The display control apparatus of claim 2, wherein the configuration component includes at least one memory element within which a plurality of clock configuration values are stored and the configuration component is arranged to selectively output as the control signal one of the clock configuration values based at least partly on the received indication of the number of graphics layers to be blended.

4. The display control apparatus of claim 3, wherein the configuration component is arranged to compare the indication of the number of graphics layers to be blended to at least one threshold value, and to selectively output as the control signal one of the clock configuration values based at least partly on the comparison of the indication of the number of graphics layers to be blended to the at least one threshold value.

5. The display control apparatus of claim 2, wherein the configuration component is further arranged to:
receive an indication of a current frame rate for the display device,
determine whether the current frame rate is less than a minimum frame rate threshold, and
configure the control signal to cause the clock signal generator to generate the pixel clock source signal to have a cycle period at least equal to a minimum frame rate clock cycle period.

6. The display control apparatus of claim 2, wherein the clock signal generator comprises a phase-locked loop.

7. The display control apparatus of claim 6, wherein a prescaler component within a feedback path of the phase-locked loop is arranged to receive the control signal output by the configuration component and to apply prescaling to a feedback signal of the phase-locked loop in accordance with the received control signal.

8. The display control apparatus of claim 1, further comprising a layer counter arranged to:
receive an indication of over which data channels the at least one display controller is receiving image data,
count a number of data channels over which the at least one display controller is receiving image data, and
output the counted number of data channels as the indication of the number of graphics layers to be blended.

9. The display control apparatus of claim 8, wherein the layer counter is arranged to receive indications from input buffers of the at least one display controller of over which data channels image data is being received.

10. A pixel clock control component comprising a configuration component arranged to receive an indication of a number of graphics layers to be blended to create composite pixel data, and to cause a pixel clock for the transmission of the composite pixel data to at least one display device to be configured based at least partly on the received indication of the number of graphics layers to be blended.

11. The pixel clock control component of claim 10, further comprising a clock signal generator arranged to receive a control signal and to generate a pixel clock source signal based at least partly on the received control signal;
wherein the configuration component is arranged to configure and output the control signal to the clock signal generator based at least partly on the received indication of the number of graphics layers to be blended.

12. The pixel clock control component of claim 11, wherein the configuration component includes at least one memory element within which a plurality of clock configuration values are stored and the configuration component is arranged to selectively output as the control signal one of the clock configuration values based at least partly on the received indication of the number of graphics layers to be blended.

13. The pixel clock control component of claim 12, wherein the configuration component is arranged to compare the indication of the number of graphics layers to be blended to at least one threshold value, and to selectively output as the control signal one of the clock configuration values based at least partly on the comparison of the indication of the number of graphics layers to be blended to the at least one threshold value.

14. The pixel clock control component of claim 11, wherein the configuration component is further arranged to:
receive an indication of a current frame rate for the display device,
determine whether the current frame rate is less than a minimum frame rate threshold, and
configure the control signal to cause the clock signal generator to generate the pixel clock source signal to have a cycle period at least equal to a minimum frame rate clock cycle period.

15. The pixel clock control component of claim 11, wherein the clock signal generator comprises a phase-locked loop.

16. The pixel clock control component of claim 15, wherein a prescaler component within a feedback path of the phase-locked loop is arranged to receive the control signal output by the configuration component and to apply prescaling to a feedback signal of the phase-locked loop in accordance with the received control signal.

17. A method of dynamically configuring a pixel clock for transmission of composite pixel data to at least one display device; the method comprises:
receiving an indication of a number of graphics layers to be blended for the composite pixel data, and
configuring the pixel clock based at least partly on the received indication of the number of graphics layers to be blended.

18. The method of claim 17, comprising selectively outputting as a control signal to a pixel clock source signal generator one of a plurality of clock configuration values stored within at least one memory element based at least partly on the received indication of the number of graphics layers to be blended.

19. The method of claim 18, comprising comparing the indication of the number of graphics layers to be blended to at least one threshold value, and selectively outputting as a control signal to a pixel clock source signal generator one of a plurality of clock configuration values stored within at least one memory element based at least partly on the received indication of the number of graphics layers to be blended.

20. The method of claim 17, further comprising:
receiving an indication of a current frame rate for the display device,
determining whether the current frame rate is less than a minimum frame rate threshold, and
configuring the pixel clock to have a cycle period at least equal to a minimum frame rate clock cycle period.
